(19) United States
(12) Patent Application Publication
(10) Pub. No.: US 2024/0258945 A1
(43) Pub. Date: Aug. 1, 2024

(54) SEMICONDUCTOR INTEGRATED CIRCUIT DEVICE, MOTOR SYSTEM AND VEHICLE

(71) Applicant: ROHM CO., LTD., KYOTO (JP)

(72) Inventor: Yoshinori Oka, KYOTO (JP)

(21) Appl. No.: 18/409,556

(22) Filed: Jan. 10, 2024

(30) Foreign Application Priority Data
Jan. 30, 2023 (JP) 2023-012185

(51) Int. Cl. H02P 27/06; H02P 25/03

(52) U.S. Cl. CPC H02P 27/06; H02P 25/03

(57) ABSTRACT

The present disclosure provides a semiconductor integrated circuit device. The semiconductor integrated circuit device includes: a first power supply terminal, configured to receive a first voltage; a second power supply terminal, configured to receive a second voltage; an internal power supply circuit; and a selection circuit, configured to select whether supplying the first voltage to the internal power supply circuit or supplying the second voltage to the internal power supply circuit according to a comparison result between the first voltage and a reference voltage or the second voltage and the reference voltage. The second voltage is a voltage lower than the first voltage and during a current flowing through the second power supply terminal.

### TECHNICAL FIELD

The present disclosure relates to a semiconductor integrated circuit device, a motor system and a vehicle.

### BACKGROUND

The semiconductor integrated circuit device disclosed in patent document 1 includes a logic circuit operating under a low power supply voltage, and a pre-driver circuit operating under a high power supply voltage. Moreover, the semiconductor integrated circuit device disclosed in patent pre-driver circuit 1 includes an internal power supply circuit that generates an internal power supply voltage according to a voltage applied to a power supply terminal. The internal power supply voltage is used as the low power supply voltage supplied to the logic circuit.

### PRIOR ART DOCUMENT

### [Patent Publication]

[Patent document 1] Japan Patent Publication No. 2013-102658

### BRIEF DESCRIPTION OF THE DRAWINGS

FIG. 1 is a diagram of a brief configuration of a motor system according to a first embodiment.

FIG. 2 is a diagram of a relation between an external power supply voltage and a voltage applied to a first power supply terminal.

FIG. 3 is a diagram of a relation among an external power supply voltage, a voltage applied to a second power supply terminal, and a voltage supplied to an internal power supply circuit.

FIG. 4 is a diagram of a brief configuration of a motor system according to a second embodiment.

FIG. 5 is a diagram of an appearance of a vehicle X.

### DETAILED DESCRIPTION OF THE EMBODIMENTS

In the present disclosure, a reference voltage refers to a constant voltage in an ideal state, and in practice may be a voltage slightly varying in response to temperature changes.

### First Embodiment

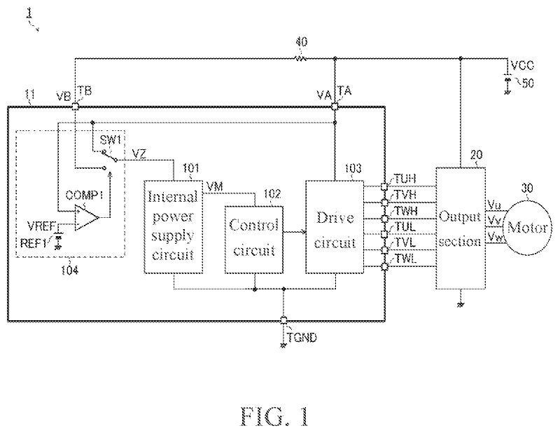

FIG. 1 shows a diagram of a brief configuration of a motor system 1 according to a first embodiment. The motor system 1 includes a semiconductor integrated circuit device 11, an output section 20, a motor 30 and an external resistor 40.

The semiconductor integrated circuit device 11 is configured as a motor driver for driving the motor 30. The semiconductor integrated circuit device 11 drives the motor 30 via the output section 20.

The output section 20 is a three-phase inverter. The output section 20 converts an external power supply voltage VCC output by an external power supply 50 into motor driving voltages Vu, Vv and Vw of three phases, and supplies the motor driving voltages Vu, Vv and Vw of three phases to the motor 30.

The motor 30 is a three-phase brushless motor driven and rotated by the motor driving voltages Vu, Vv and Vw from the output section 20.

The semiconductor integrated circuit device 11 includes an internal power supply circuit 101, a control circuit 102, a drive circuit 103 and a selection circuit 104.

Moreover, as a mechanism for asserting external electrical connections of the device, the semiconductor integrated circuit device 11 includes multiple external terminals including a first power supply terminal TA, a second power supply terminal TB, a first output terminal TUH, a second output terminal TVH, a third output terminal TWH, a fourth output terminal TUL, a fifth output terminal TVL, a sixth output terminal TWL and a ground terminal TGND.

On an outside of the semiconductor integrated circuit device 11, the first power supply terminal TA is connected to a positive electrode of the external power supply 50, a first end of the external resistor 40, and a power supply terminal of the output section 20. On the outside of the semiconductor integrated circuit device 11, the second power supply terminal TB is connected to a second end of the external resistor 40. On the outside of the semiconductor integrated circuit device 11, the output section 20 is connected to the first output terminal TUH, the second output terminal TVH, the third output terminal TWH, the fourth output terminal TUL, the fifth output terminal TVL, and the sixth output terminal TWL. On the outside of the semiconductor integrated circuit device 11, the ground terminal TGND is connected to ground.

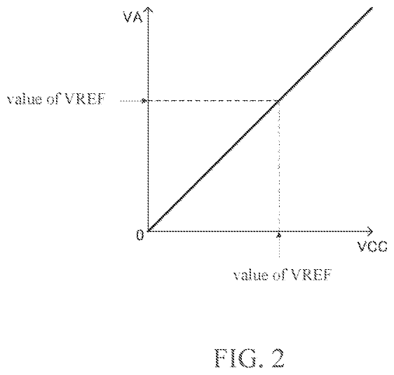

A value of a voltage VA applied to the first power supply terminal TA is equal to a value of the external power supply voltage VCC output from the external power supply 50. Thus, the external power supply voltage VCC and the voltage VA form a relation in FIG. 2, that is, a ratio relation with a slope of 1.

When a current flows through the external resistor 40, a voltage VB applied to the second power supply terminal TB becomes lower than the external power supply voltage VCC due to a voltage drop of the external resistor 40. That is to say, when a current flows through the external resistor 40 and to the second power supply terminal TB, the voltage VB applied to the second power supply terminal TB is lower than the voltage VA applied to the first power supply terminal TA.

When no current flows through the external resistor 40, the value of the voltage VB applied to the second power supply terminal TB is equal to the value of the external power supply voltage VCC output from the external power supply 50. That is to say, when no current flows through the external resistor 40 or to the second power supply terminal TB, the value of the voltage VB applied to the second power supply terminal TB is equal to the value of the voltage VA applied to the first power supply terminal TA.

The internal power supply circuit 101 steps down a voltage VZ output from the selection circuit 104 and generates an internal power supply voltage VM. The internal power supply voltage VM is used as a power supply voltage for the control circuit 102.

The control circuit 102 uses the internal power supply voltage VM as a power supply voltage. The control circuit 102 controls the drive circuit 103.

The drive circuit 103 uses the voltage VA as a power supply voltage. The drive circuit 103 generates six gate driving signals according to control of the control circuit 102. The six gate driving signals output from the drive circuit 103 are supplied to the output section 20 via the first output terminal TUH, the second output terminal TVH, the third output terminal TWH, the fourth output terminal TUL, the fifth output terminal TVL, and the sixth output terminal TWL.

The selection circuit 104 selects whether supplying the voltage VA to the internal power supply circuit 101 or supplying the voltage VB to the internal power supply circuit 101 according to a comparison result between the voltage VA and a reference voltage VREF. The selection circuit 104 includes a reference voltage circuit REF1, a comparator COMP1 and a switch SW1.

The reference voltage circuit REF1 generates the reference voltage VREF.

The comparator COMP1 compares the voltage VA with the reference voltage VREF. An output signal of the comparator COMP1 becomes high level when the voltage VA is higher than the reference voltage VREF. On the other hand, the output signal of the comparator COMP1 becomes lower level when the voltage VA is lower than the reference voltage VREF.

The switch SW1 operates based on the output signal of the comparator COMP1.

The switch SW1 supplies the voltage VB to the internal power supply circuit 101 if the output signal of the comparator COMP1 is high level. That is to say, the voltage VB becomes the voltage VZ when the voltage VA is higher than the reference voltage VREF. Thus, even if the external power supply voltage VCC increases, an increase in a difference between the voltage VZ and the internal power supply voltage VM can be inhibited, hence suppressing heat generation of the semiconductor integrated circuit device 11.

The switch SW1 supplies the voltage VA to the internal power supply circuit 101 if the output signal of the comparator COMP1 is low level. That is to say, the voltage VA becomes the voltage VZ when the voltage VA is lower than the reference voltage VREF. Thus, even if the external power supply voltage VCC decreases, malfunction of the internal power supply circuit 101 can be inhibited. In addition, at this point in time, the value of the voltage VB is equal to the value of the voltage VA since the second power supply terminal TB becomes open-circuit and no current flows through the second power supply terminal TB.

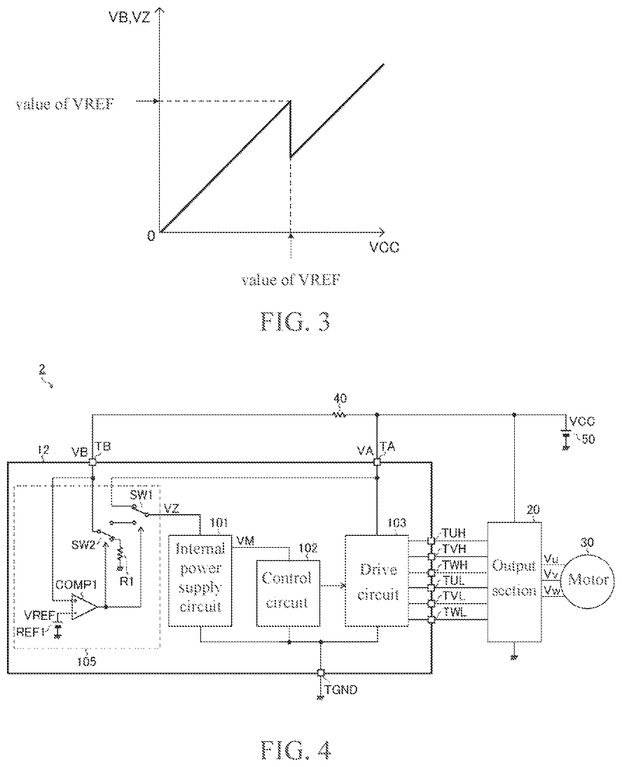

With the operation of the switch SW1, the external power supply voltage VCC, the voltage VB and the voltage VZ form the relation in FIG. 3

As clearly described above, the semiconductor integrated circuit device 11 is capable of expanding an appropriate range of the external power supply voltage VCC.

Moreover, in comparison with a semiconductor integrated circuit device 12 described below, the semiconductor integrated circuit device 11 is outstanding in terms of the configuration of the selection circuit 104 and simple operations.

### Second Embodiment

FIG. 4 shows a diagram of a brief configuration of a motor system 2 according to a second embodiment. In this embodiment, details of the parts in common with the first embodiment are appropriately omitted.

The motor system 2 includes a semiconductor integrated circuit device 12, an output section 20, a motor 30 and an external resistor 40.

The semiconductor integrated circuit device 12 differs from the semiconductor integrated circuit device 11 of the first embodiment in the aspect of including a selection circuit 105, and is the same as the semiconductor integrated circuit device 11 of the first embodiment apart from the aspect above.

The semiconductor integrated circuit device 12 includes the selection circuit 105.

The selection circuit 105 selects whether supplying the voltage VA to the internal power supply circuit 101 or supplying the voltage VB to the internal power supply circuit 101 according to a comparison result between the voltage VB and the reference voltage VREF. The selection circuit 105 includes a reference voltage circuit REF1, a comparator COMP1, a switch SW1 and a switch SW2. Moreover, in this embodiment, the reference voltage circuit REF1 has a function of varying the reference voltage VREF according to a level of an output signal of the comparator COMP1.

The comparator COM1 compares the voltage VB with the reference voltage VREF. An output signal of the comparator COMP1 becomes high level when the voltage VB is higher than the reference voltage VREF. On the other hand, the output signal of the comparator COMP1 becomes lower level when the voltage VB is lower than the reference voltage VREF.

The switch SW1 operates based on the output signal of the comparator COMP1. Similar to the switch SW1, the switch SW2 operates based on the output signal of the comparator COMP1.

The switch SW2 supplies the voltage VB to the switch SW1, and the switch SW1 supplies the voltage VB to the internal power supply circuit 101 if the output signal of the comparator COMP1 is high level. That is to say, the voltage VB becomes the voltage VZ when the voltage VB is higher than the reference voltage VREF. Thus, even if the external power supply voltage VCC increases, an increase in a difference between the voltage VZ and the internal power supply voltage VM can be inhibited, hence suppressing heat generation of the semiconductor integrated circuit device 12.

The switch SW2 supplies the voltage VB to a resistor R1, and the switch SW1 supplies the voltage VA to the internal power supply circuit 101 if the output signal of the comparator COMP1 is low level. That is to say, the voltage VA becomes the voltage VZ when the voltage VB is lower than the reference voltage VREF. Thus, even if the external power supply voltage VCC decreases, malfunction of the internal power supply circuit 101 can be inhibited. In addition, in this embodiment, by supplying the voltage VB from the switch SW2 to the resistor R1, open-circuit of the second power supply terminal TB and no current flowing through the second power supply terminal TB are prevented.

### Application Example

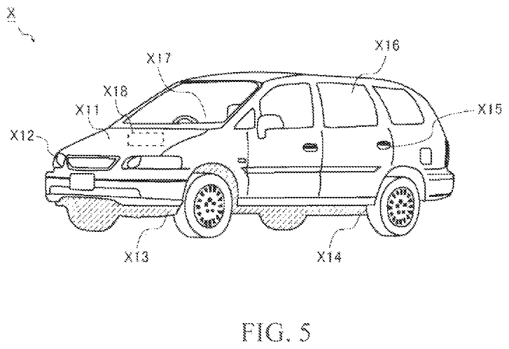

FIG. 5 shows a diagram of an appearance of a vehicle X. The vehicle X of this configuration example is mounted with various electronic apparatuses X11 to X18 that receive a voltage output from a battery (not shown) to operate accordingly. Moreover, for illustration purposes, the positions for mounting these electronic apparatuses X11 to X18 in the drawing may not be exactly as those in an actual situation.

The electronic apparatus X11 is an engine control unit that performs engine-related control (fuel injection control, electronic throttle control, idle speed control, oxygen sensor heater control, and automatic cruise control).

The electronic apparatus X12 is a lamp control unit that performs dimming and lighting control of a high intensity discharged lamp (HID), a daytime running lamp (DRL), and so on.

The electronic apparatus X13 is a transmission device control unit that performs transmission device-related control.

The electronic apparatus X14 is a brake unit that performs motion-related control of the vehicle X such as anti-lock brake system (ABS) control, electric power steering control, electronic suspension control, and so on.

The electronic apparatus X15 is a safety control unit that performs driving control such as a door lock and an antitheft alarm.

The electronic apparatus 16X is, for example, an electronic apparatus such as a wiper, power rearview mirror, power window, damper (shock absorber), power sunroof and power seat, which is assembled on the vehicle X at the factory delivery stage as standard accessories or manufacturer optional accessories.

The electronic apparatus X17 is, for example, an electronic apparatus such as a vehicle audiovisual (AV) device, car navigation system and electronic toll collection (ETC) system, which can be mounted on the vehicle X as a user optional accessory as desired.

The electronic apparatus X18 is, for example, an electronic apparatus including a high-voltage system motor such as a vehicle-mounted blower, oil pump, water pump, battery cooling fan, etc. Moreover, the motor system 1 described above can be assembled at these electronic apparatuses X18.

### <Other>

Moreover, in addition to the embodiments, various modifications may be applied to the configurations of the present disclosure without departing from the scope of the inventive subject thereof. It should be understood that all aspects of the embodiments are illustrative rather than restrictive, and it should also be understood that the technical scope of the present disclosure is not described by the embodiments but is described by the appended claims, and aims at encompassing all modifications of equivalent meanings of the claims within the scope.

For example, a hysteresis comparator can be used in substitution for the comparator COMP1.

A combination of a first circuit operating under a low power supply voltage and a second circuit operating under a high power supply voltage can be a combination other than the combination of the control circuit 102 and the drive circuit 103.

### <Note>

A note is attached to the present disclosure to show specific configuration examples of the embodiments above.

A semiconductor integrated circuit device (11, 12) of the present disclosure is configured as (a first configuration) comprising:
a first power supply terminal (TA), configured to receive a first voltage (VA);
a second power supply terminal (TB), configured to receive a second voltage (VB);
an internal power supply circuit (101); and
a selection circuit (104, 105), configured to select whether supplying the first voltage to the internal power supply circuit or supplying the second voltage to the internal power supply circuit according to a comparison result between the first voltage and a reference voltage (VREF) or the second voltage and the reference voltage, wherein
the second voltage is a voltage lower than the first voltage during a current flowing through the second power supply terminal.

The semiconductor integrated circuit device of the first configuration can also be configured as (a second configuration), wherein the first power supply terminal is configured to be connected to a first end of a resistor (40) externally connected to the semiconductor integrated circuit device and applied with the first voltage, and the second power supply terminal is configured to be connected to a second end of the resistor.

The semiconductor integrated circuit device of the first or second configuration can also be configured as (a third configuration) comprising a first circuit (102), wherein the internal power supply circuit is configured to generate a third voltage (VM) based on a voltage (VZ) supplied from the selection circuit, and supply the third voltage to the first circuit.

The semiconductor integrated circuit device of any one of the first to third configurations can also be configured as (a fourth configuration) comprising a second circuit (103), wherein the first voltage is supplied to the second circuit.

The semiconductor integrated circuit device of any one of the first to fourth configurations can also be configured as (a fifth configuration), wherein the selection circuit is configured to select whether supplying the first voltage to the internal power supply circuit or supplying the second voltage to the internal power supply circuit according to a comparison result between the first voltage and the reference voltage.

The semiconductor integrated circuit device of any one of the first to fifth configurations can also be configured as (a sixth configuration), wherein the semiconductor integrated circuit device is configured as a motor driver for driving a motor (30).

A motor system (1, 2) of the present disclosure is configured as (a seventh configuration) comprising the semiconductor integrated circuit device of the sixth configuration, and the motor.

A vehicle (X) of the present disclosure is configured as (an eighth configuration) comprising the motor system of the seventh configuration.

1. A semiconductor integrated circuit device, comprising:
a first power supply terminal, configured to receive a first voltage;
a second power supply terminal, configured to receive a second voltage;
an internal power supply circuit; and
a selection circuit, configured to select whether supplying the first voltage to the internal power supply circuit or supplying the second voltage to the internal power supply circuit according to a comparison result between the first voltage and a reference voltage or the second voltage and the reference voltage, wherein
the second voltage is a voltage lower than the first voltage and during a current flowing through the second power supply terminal.

2. The semiconductor integrated circuit device of claim 1, wherein
the first power supply terminal is configured to be connected to a first end of a resistor externally connected to the semiconductor integrated circuit device and applied with the first voltage, and
the second power supply terminal is configured to be connected to a second end of the resistor.

3. The semiconductor integrated circuit device of claim 1, further comprising a first circuit, wherein the internal power supply circuit is configured to
generate a third voltage based on a voltage supplied from the selection circuit, and
supply the third voltage to the first circuit.

4. The semiconductor integrated circuit device of claim 1, further comprising a second circuit, wherein the first voltage is supplied to the second circuit.

5. The semiconductor integrated circuit device of claim 1, wherein the selection circuit is configured to select whether supplying the first voltage to the internal power supply circuit or supplying the second voltage to the internal power supply circuit according to a comparison result between the first voltage and the reference voltage.

6. The semiconductor integrated circuit device of claim 1, wherein the semiconductor integrated circuit device is configured as a motor driver for driving a motor.

7. The semiconductor integrated circuit device of claim 2, wherein the semiconductor integrated circuit device is configured as a motor driver for driving a motor.

8. The semiconductor integrated circuit device of claim 3, wherein the semiconductor integrated circuit device is configured as a motor driver for driving a motor.

9. The semiconductor integrated circuit device of claim 4, wherein the semiconductor integrated circuit device is configured as a motor driver for driving a motor.

10. The semiconductor integrated circuit device of claim 5, wherein the semiconductor integrated circuit device is configured as a motor driver for driving a motor.

11. A motor system, comprising:
the semiconductor integrated circuit device of claim 6; and
the motor.

12. A vehicle, comprising the motor system of claim 11.
